(19) United States
(12) Patent Application Publication
(10) Pub. No.: US 2016/0321609 A1
(43) Pub. Date: Nov. 3, 2016

(54) DECISION SUPPORT TOOL FOR BUSINESS RULES MANAGEMENT IN A BOOKING SYSTEM

(71) Applicant: International Business Machines Corporation, Armonk, NY (US)

(72) Inventors: Parijat Dube, Yorktown Heights, NY (US); Joao P. M. Goncalves, Wappingers Falls, NY (US); Shilpa N. Mahatma, Mohegan Lake, NY (US); Milind R. Naphade, Cupertino, CA (US)

(21) Appl. No.: 14/700,626

(22) Filed: Apr. 30, 2015

(51) Int. Cl. G06Q 10/08

(52) U.S. Cl. CPC G06Q 10/08355; G06Q 10/0838

(57) ABSTRACT

A method includes obtaining a demand specification specifying a plurality of multi-modal freight shipment scenarios, each of the multi-modal freight shipment scenarios including at least a destination and an origin, generating, with a booking tool, a plurality of feasible multi-modal routes for each of the multi-modal freight shipment scenarios using route information from a carrier database, determining a plurality of business compliant routes among the plurality of feasible multi-modal routes for each of the multi-modal freight shipment scenarios using a rules specification specifying different business rules for each of the multi-modal freight shipment scenarios, comparing the multi-modal freight shipment scenarios by the business compliant routes determined for each respective one of the multi-modal freight shipment scenarios, and identifying at least one business rule, among the different business rules, affecting an aggregate cost-savings using the comparison of the multi-modal freight shipment scenarios.

### STATEMENT REGARDING PRIOR DISCLOSURES BY THE INVENTOR OR A JOINT INVENTOR

The following disclosure(s) are submitted under 35 U.S.C. §102(b)(1)(A):

DISCLOSURE(S): PARIJAT DUBE, et al., “Simulation Based Analytics for Efficient Planning and Management in Multimodal Freight Transportation Industry,” Proceedings of the 2014 Winter Simulation Conference, Dec. 7, 2014, Pages 1943-1954.

### BACKGROUND

The present invention relates to the electrical, electronic and computer arts, and more particularly to a method for automating business rules management in a booking system.

Multimodal freight transportation involves moving freight through different channels, often including a combination of air, water and land based transportation. Multimodal freight transportation planning is a complex problem involving different operations including transport, warehousing, distribution, and freight forwarding.

### BRIEF SUMMARY

According to an exemplary embodiment of the present invention, a method includes obtaining a demand specification specifying a plurality of multi-modal freight shipment scenarios, each of the multi-modal freight shipment scenarios including at least a destination and an origin, generating, with a booking tool, a plurality of feasible multi-modal routes for each of the multi-modal freight shipment scenarios using route information from a carrier database, determining a plurality of business compliant routes among the plurality of feasible multi-modal routes for each of the multi-modal freight shipment scenarios using a rules specification specifying different business rules for each of the multi-modal freight shipment scenarios, comparing the multi-modal freight shipment scenarios by the business compliant routes determined for each respective one of the multi-modal freight shipment scenarios, and identifying at least one business rule, among the different business rules, affecting an aggregate cost-savings using the comparison of the multi-modal freight shipment scenarios.

According to an exemplary embodiment of the present invention, a method includes obtaining a demand specification specifying a plurality of multi-modal freight shipment scenarios, each of the multi-modal freight shipment scenarios including at least a destination and an origin, receiving a booking request, generating, using a booking tool, a plurality of feasible multi-modal routes for each of the multi-modal freight shipment scenarios using route information from a carrier database, determining a plurality of business compliant routes among the plurality of feasible multi-modal routes for each of the multi-modal freight shipment scenarios using a rules specification specifying different business rules for each of the multi-modal freight shipment scenarios, and booking a route selected from among the plurality of business compliant routes in response to the booking request.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

### BRIEF DESCRIPTION OF THE SEVERAL VIEWS OF THE DRAWINGS

FIG. 1 depicts a cloud computing node according to an embodiment of the present invention;

FIG. 2 depicts a cloud computing environment according to an embodiment of the present invention;

FIG. 3 depicts abstraction model layers according to an embodiment of the present invention;

FIG. 4 shows an exemplary multimodal freight network according to an exemplary embodiment of the present invention;

FIG. 5 presents an exemplary booking system according to an exemplary embodiment of the invention;

FIG. 6 presents an exemplary booking message flow according to an exemplary embodiment of the invention;

FIG. 7 depicts an exemplary flow chart for booking according to an exemplary embodiment of the invention;

FIG. 8 shows exemplary dates used to define a time window according to an exemplary embodiment of the invention;

FIG. 9 presents an exemplary flow chart for business rules management according to an exemplary embodiment of the invention;

FIG. 10 presents an exemplary flow chart for business rules management according to an exemplary embodiment of the invention;

FIG. 11 presents an exemplary flow chart for creating a business rules management report according to an exemplary embodiment of the invention; and

FIG. 12 depicts a computer system that may be useful in implementing one or more exemplary embodiments and/or elements of the invention.

### DETAILED DESCRIPTION

Operations of the freight industry are tied to several external factors including network coverage, carriers and their schedules, existing contractual agreements with carriers and clients, carrier capacity constraints, market conditions, weather conditions, etc. Many planning and operational decisions need to be made under uncertain conditions associated with weather, market, available capacity, and the like. The day-to-day operations of the freight industry are governed by a complex set of business rules involving service agreements with the clients, contractual agreements with the carriers and forwarders' own business objectives, etc. According to an exemplary embodiment of the present invention, a decision support system and method is described for end-to-end route optimization and planning in a multimodal freight transportation environment.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

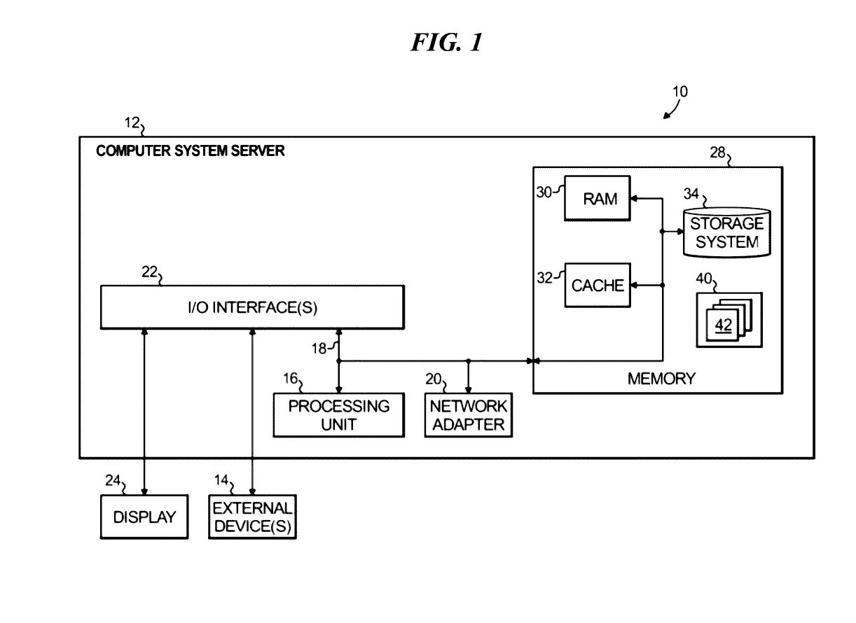

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, and external disk drive arrays, RAID systems, tape drives, and data archival storage systems, etc.

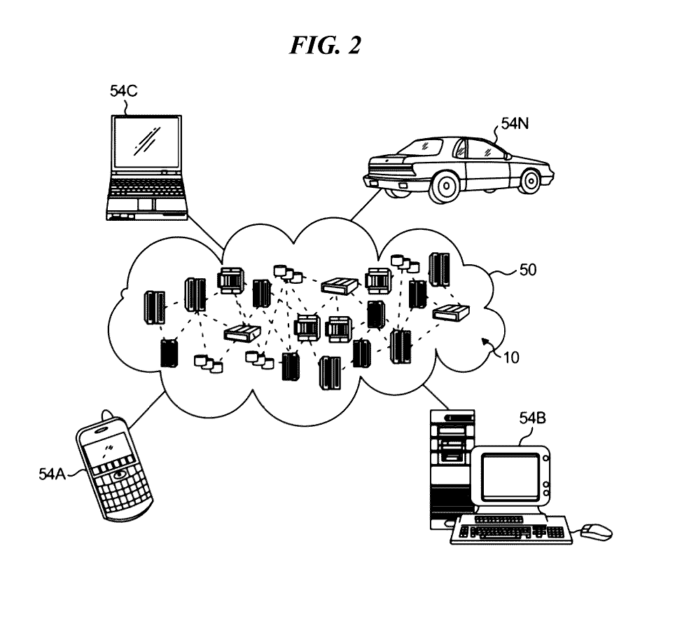

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

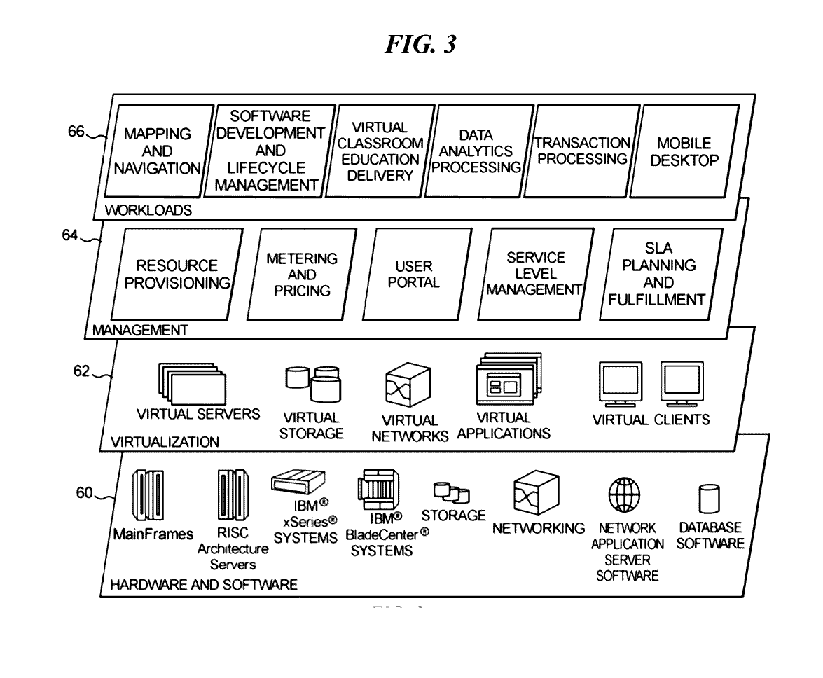

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and mobile desktop.

A freight transportation network typically has three main stake-holders: (i) shippers, (ii) freight forwarders, and (iii) carriers. Freight forwarders are responsible for end-to-end supply chain management of the freight transportation. The carriers are either already selected by the shippers or the freight forwarders also provide carrier selection services to the shippers. In the former case, the shippers typically have established contracts with the carriers with pre-negotiated rates.

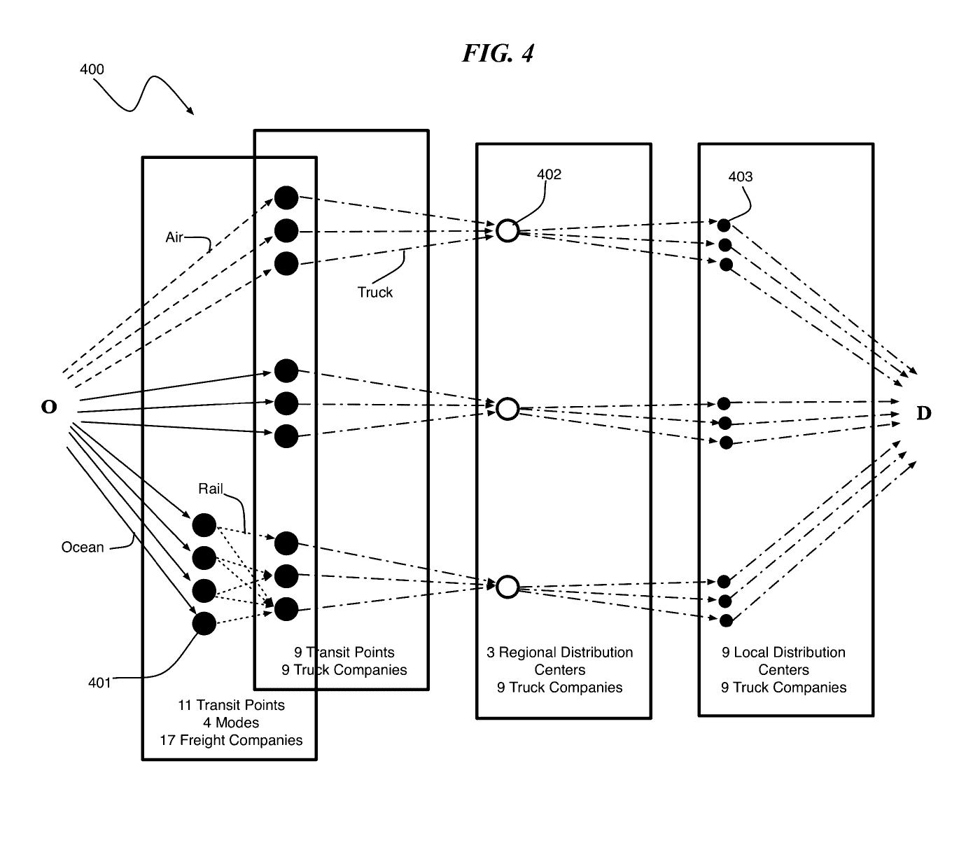

In operation, the freight forwarders operate on “trade lanes,” which can be characterized by a set of origin-destination (O-D) port pairs restricted to some geography, e.g., mainland China to North-West Europe, which includes fixed O-D port pairs like Shanghai-Felixstowe, Xiamen-Rotterdam, Yantian-Belfast, etc. FIG. 4 shows an exemplary multimodal freight network 400 between two transportation hubs (O and D). The exemplary network includes up to five legs involving ocean, air and land (truck and rail) routes with transit ports, e.g., 401, regional distribution centers, e.g., 402, and local distribution centers, e.g., 403. Freight forwarders offer different types of services including less-than-container load shipments, full container load shipments, breakbulk shipping services, project forwarding, partial and full charter services, freight management services, bundled solutions, kitting and labeling, etc.

One or more embodiments advantageously provide an integrated system to automate the booking process. Indeed, one or more embodiments automate the process of booking freight transportation. One or more embodiments provide an integrated system that provides the booking agent the following functionality:

decision support tool;

auto-quoting tool;

automated booking tool; and

booking analytics support to provide value to customer (for example, in the form of recommended cost-effective changes to the initial decision constraints).

One or more embodiments of the present invention are implemented as software that takes inputs from the booking agent, uses data stored in a database and also obtained by electronic transfer from other systems (for example, by connecting to a website where public relevant information is available and downloading such information and/or by using Electronic Data Interchange (EDI) to obtain relevant and up to date information from carriers and other partners), and provides recommendations regarding possible transportation alternatives and their corresponding rates. One or more embodiments of the present invention allow the booking agent to select a particular transportation solution and automatically proceed with the booking. In view of the foregoing, exemplary embodiments of the present invention facilitate improved end-to-end shipping.

The system can perform functions including:

dynamic route creation and cost calculation in identifying solutions and/or identifying options from a large number of possible combinations;

automatic business rules and contract enforcement;

accounting for real time information regarding the state of the network;

adapting to day-to-day changes in the network, market, carrier;

adding value to the shipper by identifying transportation rates that are better than the rates the shipper may have with specific carriers;

etc.

One or more embodiments provide a system to automate the booking process. The booking agent inputs, into the system, the data that defines the requirements of the booking. For example, the shipment cannot depart from its origin before a certain date or/and it must arrive at the destination by a certain date. The input from the user can include many types of constraints such as a limit on the number of transportation modes, the exclusion and/or inclusion of specific carriers and ports, and the like.

A system according to a non-limiting exemplary embodiment provides support for any service type (such as door-to-door) and includes all the transportation needed to fulfill the service type requirement. Data regarding the existing transportation, such as schedules and rates, is stored in a database, which is continuously updated with new information. The exemplary system accepts programmable selection criteria, which are used to determine transportation options to be proposed to the user. The exemplary system accepts the input and proposes the transportation options, to the booking agent, that satisfy all the requirements imposed by the booking agent. In one or more embodiments, the exemplary system can propose only a certain ones of the determined transportation options to the user (e.g., the best three transportation options based on the programmable selection criteria). For each alternative transportation option, the exemplary system computes and displays different metrics such as total cost and total transit time. The exemplary system also computes and displays a measure of risk associated with each metric.

The exemplary system enforces business rules that have been previously defined. For example, if there is a preferred carrier, the exemplary system will first suggest alternatives using the preferred carrier and will only allow the booking agent to book with another carrier if certain predefined criteria are met (e.g., if the rate of the preferred carrier is more than 50% higher than the cost of an alternative carrier, the system may allow the user to book with the cheapest carrier).

The exemplary system can also recommend alternative transportation choices that do not necessarily satisfy all the requirements imposed by the booking agent but may be cost effective. Moreover, the exemplary system may recommend alternative transportation for which complete cost information is not available. These alternatives are proposed to the user and require the user to use other means to obtain the information needed to ascertain the interest of using such alternatives. For example, the user might need to call a certain carrier and ask for the rates for a specific route recommended by the system.

The exemplary system takes into account real time information regarding the state of the network when selecting the alternative transportation choices to present to the user. For example, if the exemplary system receives information that a strike is planned for a certain carrier, the system might recommend other carriers for a particular booking and/or alert the user that a certain carrier has an alert for a possible strike. If the user has updated information regarding any of the data such as rates or transit times, the user will be able to manually update the database. For example, the rate for specific truck transportation stored in the database might be different from the rate that the user can negotiate with a truck carrier. In that case, the user can manually enter the updated information and, if necessary, order the exemplary system to re-compute the recommendation.

The booking agent decides which option to choose and instructs the exemplary system to go ahead with that particular booking. The exemplary system automatically prepares the information needed to proceed with the booking and sends that information to the selected transportation carriers. In one or more embodiments, this is done electronically by Electronic Data Interchange (EDI). In the case that carriers are not prepared to exchange data using EDI, then the information can be sent automatically by another means, such as by email.

Accordingly, one or more embodiments provide a method, system, and/or computer program product to automate end-to-end route composition for multi-modal freight booking requests. In some instances, several metrics for each route are calculated as a function of corresponding metrics for individual legs. In some such instances, land transportation cost is approximated using estimated cost per unit distance when exact costs are unknown.

Some embodiments account for carrier capacity constraints, carrier relationship constraints, volume discounts offered by carriers with those discounts being local or global, and/or shipper revenue targets.

Some embodiments pre-compute nearest port(s) for a land location for rapid response. Some embodiments make use of internal data as well as external data including shipping schedules.

One or more embodiments include any one, some, or all of the following features:

multi-objective optimization under uncertainty to find the best routes for a shipment request;

accounting for volume discounts offered by carriers;

accounting for real time network conditions; and

accounting for risk factors.

One or more embodiments advantageously formulate the route identification problem using the framework of multi-objective optimization under uncertainty, thereby providing robust choices, which in turn improve network yield and resulting revenue.

One or more embodiments retrieve information in real time from external data sources and use it efficiently to calculate different metrics related to cost, transit time and risk. One or more embodiments provide a graphical user interface for input and output, functionality that allows the user to submit a booking to a carrier, and/or real time data obtained by electronic transfer from other systems.

One or more embodiments provide a booking system for multi-modal transportation that uses multi-objective optimization to find the best alternative routes for a particular shipment request. In one or more embodiments, for a particular booking request, the best routes are determined using optimization. Further, one or more embodiments support multi-modal transportation.

One or more embodiments provide an end-to-end optimization of the routing process, which takes into account various costs and routes along with carrier capacity and volume discounts. One or more embodiments deal with generation of optimized choices for an end-to-end route by accounting for static and dynamic information affecting the selection of routes. One or more embodiments describe a booking system that generates optimized routing alternatives for a specific shipment and presents those alternatives to the shipper. One or more embodiments include an optimization module that determines the best routes according to one or more criteria.

Furthermore, one or more embodiments provide a method and a system for end-to-end route composition by accounting for both static and real-time information. For each feasible route, one or more embodiments calculate a set of performance metrics and use these in an optimization framework to identify the best set of routes satisfying a business objective within specified performance constraints.

Yet further, one or more embodiments consider more complex metrics such as carrier capacity constraints and volume discounts along with costs to make an optimal route decision. One or more embodiments also consider multi modal freight route options (land, ocean, etc.) for optimal decisions.

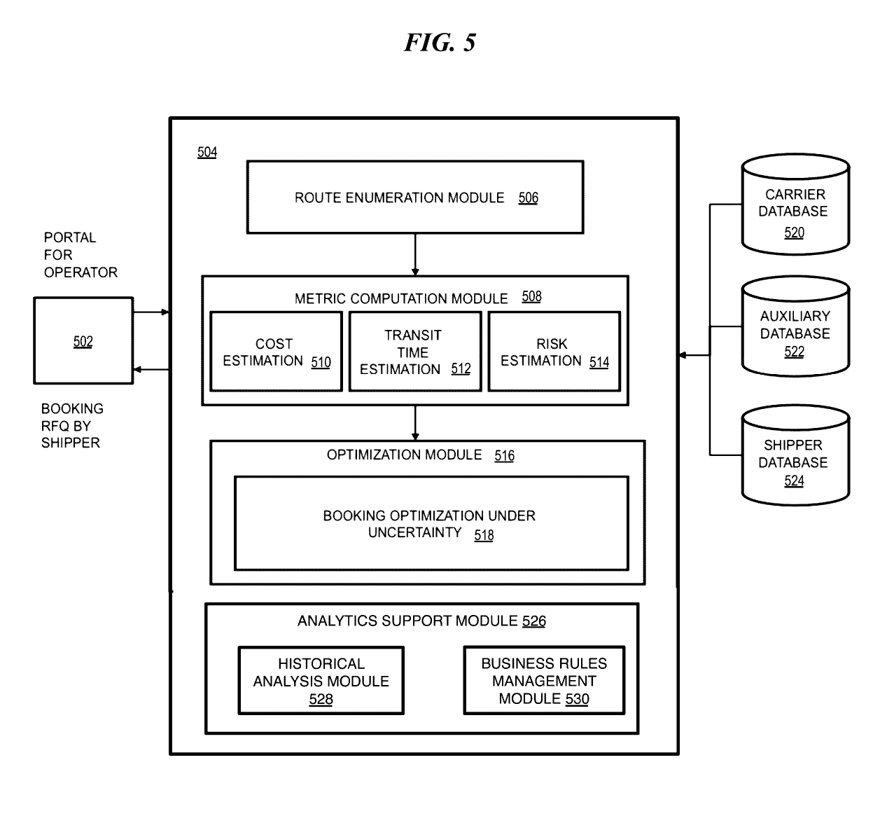

Referring now to FIG. 5, depicted therein is an exemplary decision support system 504 in accordance with an aspect of the invention. Decision support system 504 includes route enumeration module 506, metric computation module 508, and optimization module 516. Metric computation module 508 in turn includes cost estimation sub-module 510, transit time estimation sub-module 512, and risk estimation sub-module 514. Optimization module 516 implements booking optimization under uncertainty, as seen at 518. Element 502 provides a portal (e.g., web-based) which allows an operator to access system 504. It also allows a shipper to send out requests for quotation (RFQs) for booking of shipments on one or more carriers.

Also included are carrier database 520 which includes pertinent information on one or more carriers; shipper database 524 which includes pertinent information on one or more shippers using the system 504, and auxiliary database 522 which includes information on, e.g., external factors such as local news (e.g., impending strike) and weather at destinations or along shipment routes.

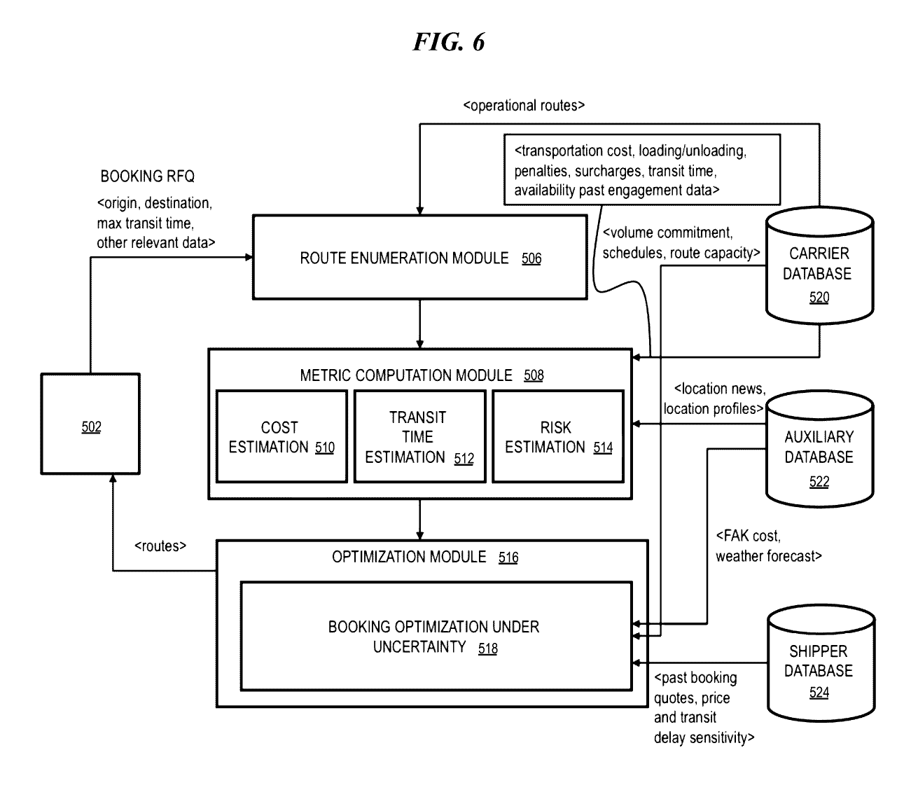

FIG. 6 presents an exemplary booking message flow according to an aspect of the invention. Element 502 communicates with route enumeration module 506 to provide same with appropriate data associated with a booking RFQ including origin, destination, maximum transit time and other relevant data. In some instances, so-called INCOTERMS can be employed; INCOTERMS are a set of rules that are used in international commerce with the purpose of clearly identifying some aspects of the transportation of goods such as responsibilities attributed to each entity involved in the transportation. Non-limiting examples of other relevant data include transit-time, carrier preference, date and time of loading and delivery, and number of twenty-foot equivalent units (TEUs). Route enumeration module 506 obtains information on operational routes from carrier database 520. Route enumeration module 506 then uses the inputs to generate feasible routes that are provided to metric computation module 508. Auxiliary database 522 provides location news and location profiles to metric computation module 508. Carrier database 520 provides transportation cost, loading and unloading penalties, surcharges, transit time, availability, free-time at ports, and past engagement data to metric computation module 508.

Optimization module 516 then carries out booking optimization under uncertainty as at 518, based on the cost, transit, and risk estimates from sub-modules 510, 512, 514 respectively. This optimization process also makes use of volume commitment, schedule, and route capacity information from carrier database 520; FAK cost and weather forecast data from auxiliary database 522; and past booking quotes, price and transit delay sensitivity data from shipper database 524. The skilled artisan will appreciate that “FAK” refers to “Freight All Kind” which is a carrier's rate that is used as a common rate for various goods. This output of the optimization process includes one or more routes displayed to the user via element 502.

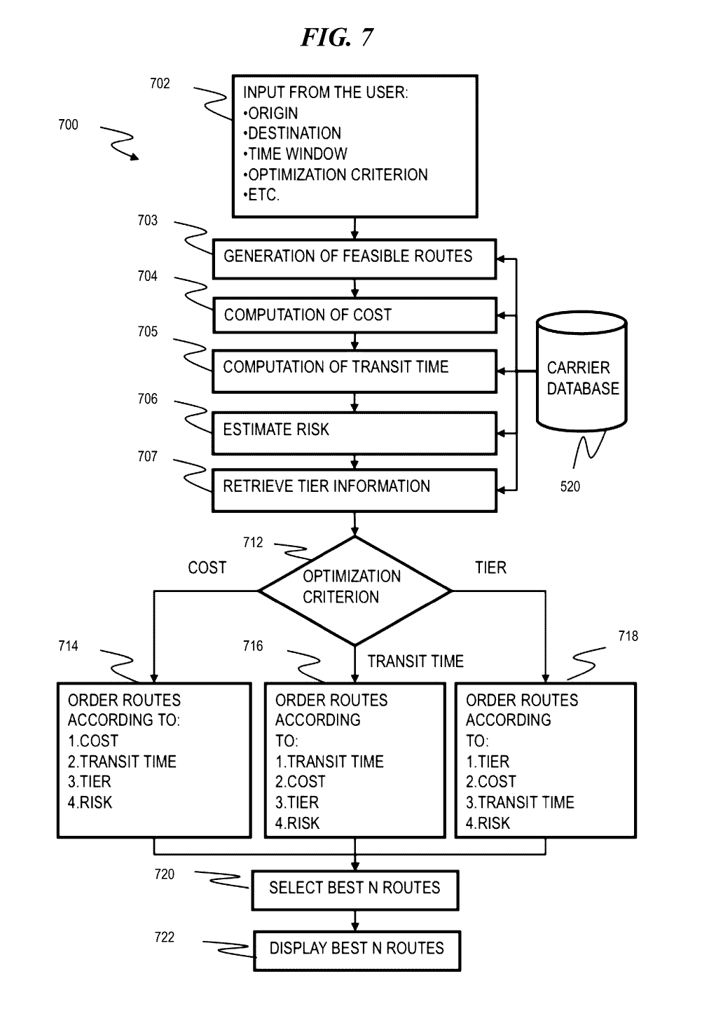

FIG. 7 depicts an exemplary flow chart 700 for booking according to an aspect of the invention. In step 702, a user provides input to the decision support system 504 via portal functionality of element 502. Exemplary input includes origin, destination, time window, what criterion/criteria (e.g., cost, speed, safety) to optimize on, and the like. Route enumeration module 506 then carries out step 703, generation of feasible routes, based on information from carrier database 520 as described elsewhere herein. Cost estimation sub-module 510 estimates cost in step 704, while transit time estimation sub-module 512 estimates transit time in step 705. Risk estimation sub-module 514 estimates risk in step 706. Optimization module 516 retrieves tier information from carrier database 520 in step 707.

In decision block 712, a decision is made whether to optimize for low cost (left-hand branch), low transit time (middle branch), or preferred tier (right-hand branch). “Tiers” refer to the case where a company codifies carriers according to preferences; for example, if a certain carrier allows a more favorable payment schedule (60 days instead of 30 days), that carrier may be preferred. Tier I may be most preferred carriers, Tier II may be less preferred, and so on (as many tiers as desired). These preferences are taken into account in the optimization. Module 516 makes the decision based on user input and then carries out the optimizations. As seen at step 714, if optimizing on cost, routes are ordered based first on lowest cost, then on lowest transit time, then on preferred tier, and then on risk. As seen at step 716, if optimizing on transit time, routes are ordered based first on lowest transit time, then on lowest cost, then on preferred tier, and then on risk. As seen at step 718, if optimizing on tier, routes are ordered based first on preferred tier, then on lowest cost, then on lowest transit time, and then on risk. The N best routes for the selected optimization criterion are determined by module 516 in step 720, and are displayed via portal functionality of element 502 in step 722. N is an arbitrary integer which can be hard-coded into the system or selected by the user; for example, the system may always give the best three (or other integer number of) choices in descending order of desirability, or may prompt the user with a query such as “how many alternatives do you wish to see). In some instances, all feasible routes may be displayed in ranked order.

It will be appreciated that the decision support system 504 provides a booking decision support tool which supports booking agents who have to respond with viable options to a request for freight transportation from a client. The tool takes as input a set of requirements that describe the transportation request and outputs a set of alternative routes. One non-limiting exemplary embodiments addresses ocean transportation of full container loads. It accommodates up to three ocean legs. One of those legs is usually an intercontinental leg on a large vessel from a major port in one continent (e.g., Shanghai in Asia) to a major port in another continent (e.g., Rotterdam in Europe). The other two legs usually involve smaller vessels going from a smaller port to a major port (or vice-versa) in the same continent (these are known as feeder legs). In addition to the ocean legs, in the non-limiting exemplary embodiments, a route may contain up to two truck legs. Truck legs are needed when the route includes transportation from an inland origin to a port and from a port to an inland destination. The different combinations of ocean and truck legs provide the tool with the capability to recommend routes for the following service types: Port to Port, Port to Door, Door to Port, and Door to Door.

A route includes a set of transportation legs. Each leg is described by its origin, its destination, the type of transportation, the type(s) of container(s) allowed, and time information. The time information available depends on the type of transportation. In the case of the ocean legs, specific schedules including departure date and arrival date are typically available. In the case of truck legs, typically, only estimates of the travel times are available. The time information for all legs in a route is combined with dwell times at ports in order to compute an estimated departure time from the route's origin, an estimated arrival time at the route's destination, and an estimated transit time for the whole route.

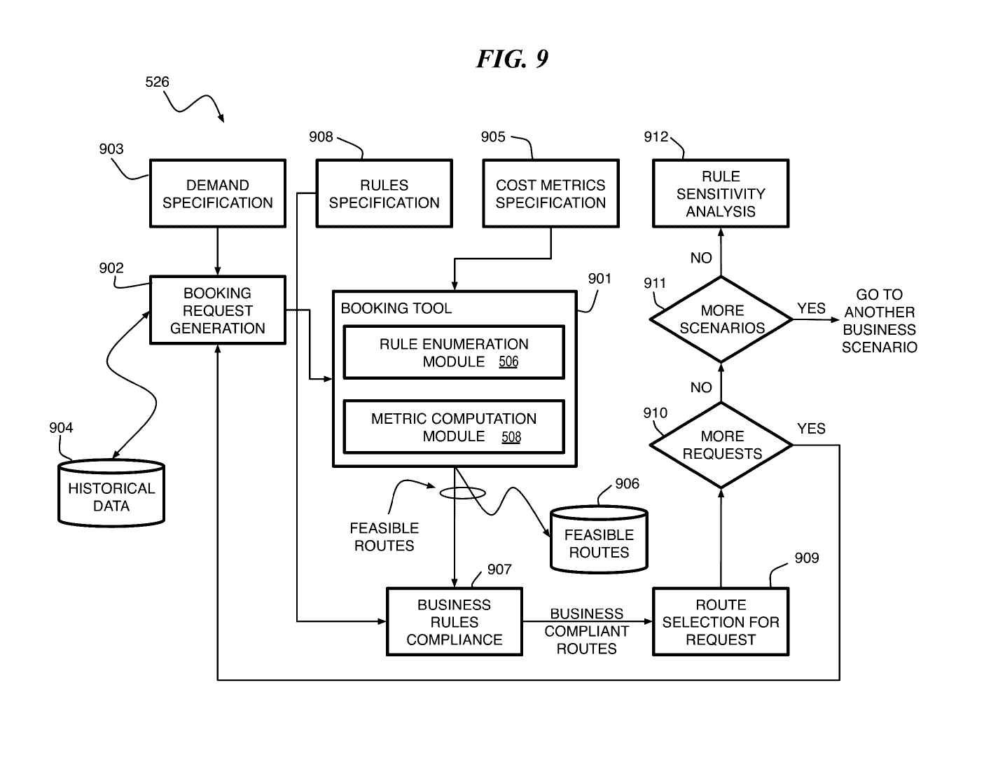

According to an exemplary embodiment of the present invention, the cost of a route is given in a cost metric specification (see FIG. 9). The cost of a route can be the sum of the transportation rates for each leg and additional charges such as terminal handling charges, risk charges, etc. Both the transportation rates and the additional charges may depend on the type of container to be used in the shipment. Therefore, the type of container (e.g., 20 foot or 40 foot container) is one of the inputs to the booking tool. Some carriers offer volume discounts, which are typically applied based on the annual volume shipped by a client. In that case, the calculation of the cost for a particular shipment request depends on the number of containers already shipped by the client on that carrier during that year. The transportation rates might also depend on the commodity to be shipped and on the existence of specific contracts between the shipper and the carrier.

For a particular transportation request, the number of routes that can fulfill the request are limited by the constraints imposed in the request. One non-limiting exemplary embodiment of a booking tool supports the following constraints:

Time window—each route has to fit within a time window specified by the user;

Total transit time—the estimated transit time of each route must be smaller than a maximum transit time specified by the user;

Include port—each route has to go through a particular port specified by the user;

Exclude port—each route must not go through a particular port specified by the user;

Include carrier—the ocean transportation in each route must be provided by a particular carrier specified by the user; and

Exclude carrier—the ocean transportation in each route must not be provided by a particular carrier specified by the user.

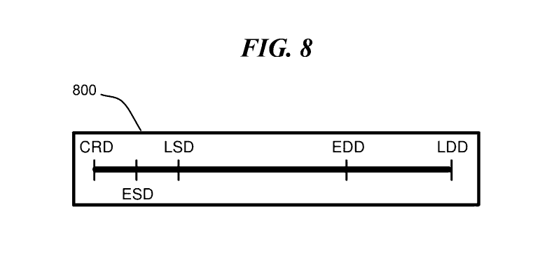

In a non-limiting exemplary embodiment, the time window 800 is specified by the user by providing the following dates (see FIG. 8):

Cargo Ready Date (CRD)—the date when the cargo is available for shipment;

Earliest Ship Date (ESD)—the earliest date when the shipment can depart;

Latest Ship Date (LSD)—the latest date when the shipment can depart;

Earliest Delivery Date (EDD)—the earliest date when the shipment can arrive at the destination; and

Latest Delivery Date (LDD)—the latest date when the shipment can arrive at the destination.

Depending on the business needs, the user may provide only a subset of the above dates. For example, the user may provide only the Cargo Ready Date and the Latest Delivery Date. In this case, the routes generated by the booking tool must depart at or after the Cargo Ready Date and must arrive at or before the Latest Delivery Date. It should be noted that if both the Cargo Ready Date and the Earliest Ship Date are provided by the user, the routes must depart at or after the latest of those two dates. If only one of them is provided, the routes must depart at or after that date.

Amongst the routes that satisfy the constraints of a transportation request there are usually some that are preferable than others from a business perspective. A non-limiting exemplary embodiment of the booking tool includes three metrics for evaluating the routes: (i) Cost, (ii) Transit time, and (iii) Tier.

The estimation of the first two metrics (cost and transit time) is described elsewhere herein. The third metric, tier, classifies a route based on the ocean carrier used. The user may prefer certain carriers over others and therefore can attribute a higher tier level to the preferred carriers. The decision on the tier of each carrier depends on the business needs and can be based on many different aspects of the carrier. For example, it can be based on the payment terms provided by the carrier or the percentage of the time that the shipments on the carrier arrive on time. It can also be based on a combination of several aspects of the carrier.

The user of the booking tool chooses a criterion for selection of the best routes based on the three metrics available. The options are: (i) Minimum cost, (ii) Minimum transit time, and (iii) Higher tier carrier. Whatever the criterion selected by the user, the booking tool outputs the details of the three best routes. With this information the user can decide which route (or possibly which routes) to use for the shipment.

FIG. 5 and FIG. 6 present a diagram of the exemplary booking tool. The tool connects to databases 520, 522, 524 where all the data needed is stored. The tool also provides a graphical user interface (via element 502) where the user enters the information about the transportation request and where the output (i.e., the best routes found) is displayed.

The modules and sub-modules of system 504 carry out at least a portion of the sequence of steps in the tool to find the best routes. The route enumeration module 506 corresponds to the construction of the feasible routes, the metric computation module 508 corresponds to the estimation of the three metrics, and the optimization module 516 corresponds to the selection of the best routes to present to the user.

In the route enumeration module 506, an enumeration algorithm is used that basically constructs feasible routes one at a time by selecting transportation legs from the database 520 that when put together satisfy all the constraints specified by the user. The output of this module is a set of feasible routes, i.e., a set of routes that satisfy all the constraints.

In the metric computation module 508, the three metrics described above (cost, transit time, and tier) are computed for all the routes generated in the route enumeration module.

Finally, in the optimization module 516 the best routes are selected from the above set of feasible routes. In a non-limiting exemplary embodiment, the optimization module sorts the feasible routes according to the criterion selected by the user (as discussed above). For example, if the user selects the criterion of minimum cost routes, then the feasible routes are ordered according to increasing cost and the tool outputs the first three routes of the sorted list, i.e., the three cheapest routes in the list.

Given the discussion thus far, it will be appreciated that, in general terms, an exemplary method, according to an aspect of the invention, includes the step 702 of obtaining, from a user (e.g., via element 502), booking information specifying a desired multi-modal freight shipment. The information includes at least destination and origin. A further step 703 includes, based on the booking information and route information from a carrier database 520, generating, with a route enumeration module 506, a plurality of feasible multi-modal routes for the desired freight shipment. A still further step 704 includes, based on cost information from the carrier database 520, computing cost for each of the feasible multi-modal routes with a cost estimation sub-module 510 of a metric computation module 508. An even further step 705 includes, based on transit time information from the carrier database 520, computing transit time for each of the feasible multi-modal routes with a transit time estimation sub-module 512 of the metric computation module 508. Yet a further step 712-720 includes, based on the cost for each of the feasible multi-modal routes and the transit time for each of the feasible multi-modal routes, carrying out multi-objective optimization under uncertainty with an optimization module 516, to obtain one or more preferred ones of the feasible multi-modal routes.

The word “multi-modal” indicates that the routes generated can include more than one mode of transportation. A simple example of multi-objective optimization is to find the route with lowest cost from the set of routes with smallest transit time. In a case where there are 10 routes with smallest transit time (e.g., 11 days), return the one route out of those 10 that has lowest cost. An example of uncertainty is the possibility of a surcharge being applied to the cost of the route after the route is booked. For each route, take as a given a probability of a surcharge being applied to its cost and if the optimization engine is asked to minimize cost it will select the route with the lowest expected cost. For example, a route that costs $1000 with a 10% probability of a $100 surcharge (has expected cost of $1010) is preferable to a route that costs $950 with an 80% probability of a $100 surcharge (has expected cost of $1030).

In some instances, a further step 707 includes retrieving tier information from the carrier database 520; in such cases, carrying out of the multi-objective optimization under uncertainty with the optimization module takes into account the tier information.

In some instances, a further step 706 includes, based on location-specific information from an auxiliary database 522, computing risk for each of the feasible routes with a risk estimation sub-module 514 of the metric computation module 508; in such instances, the multi-objective optimization under uncertainty is further based on the risk for each of the feasible routes.

In some cases, the cost information from the carrier database 520 includes volume discounts offered by at least one carrier, and the computing of the cost for each of the feasible routes with the cost estimation sub-module 510 of the metric computation module 508, in step 704, takes the volume discounts into account for at least one of the feasible routes.

In some cases, the multi-objective optimization under uncertainty is further based on real-time network conditions.

In some cases, a further step include flagging at least one of the preferred ones of the feasible multi-modal routes based on real-time network conditions.

For example, if the system knows that a port currently has a limited throughput due to construction then it can give priority to routes that do not use that port or/and flag all the routes that go through that port so that the user can make an informed decision. In summary, the information about real time network conditions can be used to influence the optimization and also as additional information given to the user about conditions affecting specific routes.

Further steps in one or more embodiments include booking shipment of goods based on the output and/or actually shipping goods in accordance with a recommendation from the system.

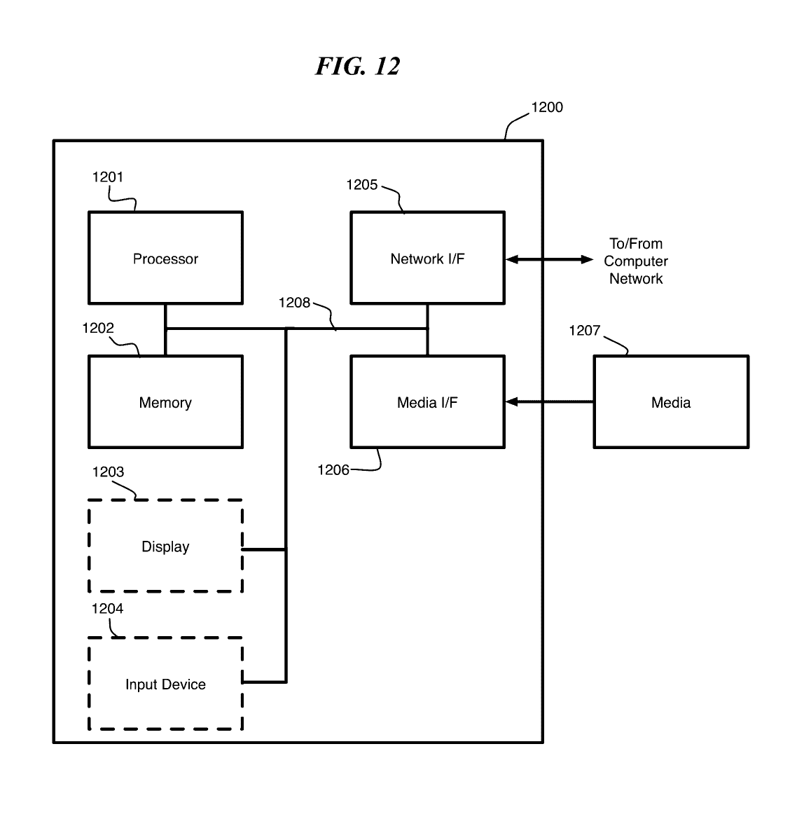

In another aspect, an exemplary apparatus (e.g., system 1200, FIG. 12, implementing system 504) includes a memory 1202 including a carrier database 520 and a plurality of distinct software modules. The plurality of distinct software modules in turn include an input-output module (e.g. provided by element 502), a route enumeration module 506, an optimization module 516, and a metric computation module 508 having a cost estimation sub-module 510 and a transit time estimation sub-module 512. At least one processor 1201 is coupled to the memory 1202, and is operative to carry out or otherwise facilitate any one, some, or all of the method steps disclosed herein.

In some cases, the memory further includes an auxiliary database 522 and/or a shipper database 524, and/or a risk estimation sub-module 514 of the metric computation module 508.

The analytics support block 526 of the decision support system 504 provides analytics support for trade lane managers and product managers. The analytics support block 526 includes multiple analytics modules. These include, for example, a historical analysis module 528 and a business rules management module 530. According to an embodiment of the present invention, the historical analysis module 528 analyzes past business transactions in the context of cost and transit-time for the purpose of identifying missed opportunities. The historical analysis module 528 also analyzes trade-offs between transit-time and cost, which can be exploited in future negotiations with clients and carriers. The business rules management module 530 provides a qualitative comparison of aggregate cost and transit-time under different combination of business rules for future business scenarios.

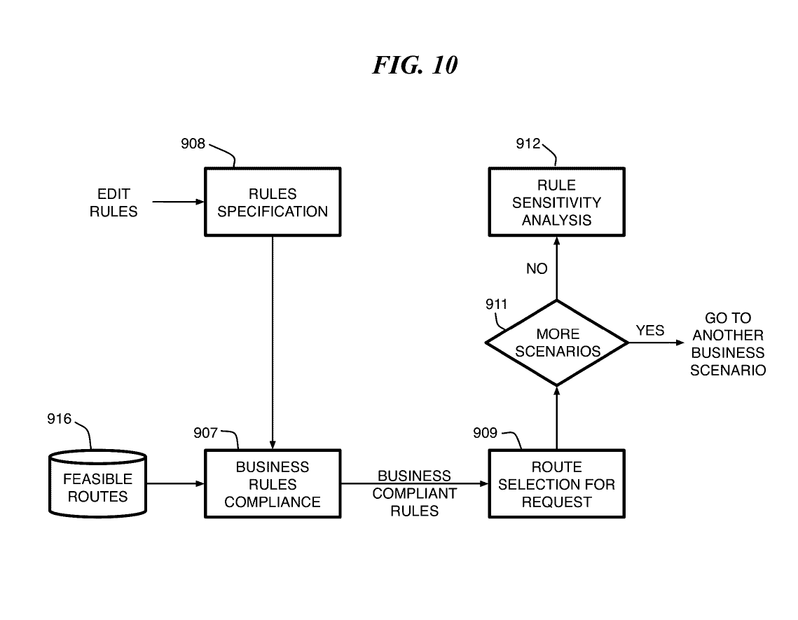

Referring to FIG. 9 and FIG. 10, the analytics support block 526 uses a booking tool 901 comprising the rule enumeration module 506 and the metric computation module 508. The booking tool 901 receives a request or hypothetical scenario 902 based on a demand specification 903 and historical data 904. The demand specification 903 gives a customer's requirements for a given period of time, e.g., a specification of shipping capacity. The booking tool 901 further receives a cost metrics specification 905. Given these inputs, the booking tool 901 determines a set of feasible routes, which can be stored in a database 906 and output to a business rules compliance block 907.

The business rules compliance block 907 uses a rule specification 908 (e.g., minimum cost route, minimum transit time route, higher tier carrier, etc.) and the set of feasible routes to determine a set of business compliant routes. The business compliant routes include routes that are feasible given the demand specification 903, the cost metrics specification 905 and the rules specification 908.

At block 909 a route is selected for the booking request. Each request and/or scenario of the customer is considered (see blocks 910 and 911).

In the case of one or more scenarios (e.g., at block 911), the rules of the rule specification 908 are edited (e.g., by the customer), and the different results (e.g., cost, efficiency, time, etc.) corresponding to different scenarios can be compared.

According to an exemplary embodiment of the present invention, at block 912, a rule sensitivity analysis is performed. For example, for each request, the cost of a selected route can be compared to a best available route (e.g., for a given cost criteria, $ amount, transit time etc.) before applying the business rules, and the business rule(s) governing the selected route. This comparison enables further refinement. For example, business rules that degrade an aggregate cost-savings can be identified (e.g., over all the requests) by aggregating cost differences across different requests for each business rule. The business rules affecting the aggregate cost-savings (e.g., as compared to a threshold or expert knowledge) can then be identified for reevaluation.

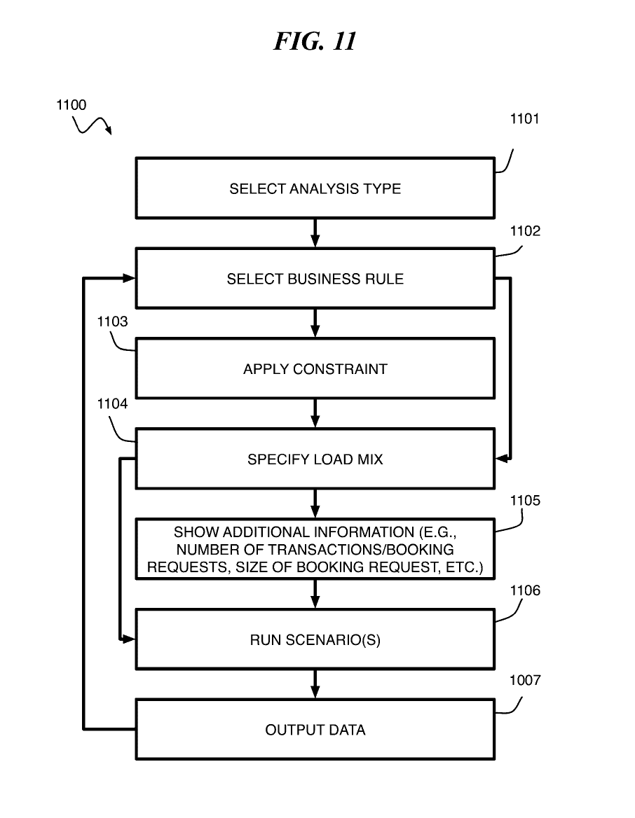

Referring to FIG. 11, in a method for creating a business rules management report, an analysis type (e.g., historical analysis module or business rules management module) is selected at block 1101. According to one or more embodiments, the report is a visualization of the comparison of the multi-modal freight shipment scenarios (e.g., showing average transit time, total cost, average TEU cost, etc.).

In the case of a historical analysis type selection, the historical analysis module 528 analyzes past transactions on multimodal shipping choices. The analysis can identify hot-spots in O-D pairs for different metrics, identify opportunities for possible cost-savings (missed opportunities), understand tradeoffs between transit time and cost which can be exploited in future negotiations with shippers/carriers, identify inconsistencies between local decisions and global business goals, etc. The decision support system 504 provides a UI for conducting a historical analysis. The historical analysis module 528 is associated with one or more use cases, including a cost-saving analysis, delay-cost tradeoffs analysis and hot-spot analysis.

Referring to the cost-savings analysis, while it is rational to select an inexpensive carrier, booking operators end up selecting other costlier carriers due to other constraints. These constraints can include limited procured capacity on cheaper carriers, longer transit times on cheaper carriers, or other business rules governing carrier selection. The historical analysis module 528 can be used to quantify the cost-savings potential on historical transactions by the freight forwarder. For each past transaction, the cheapest carrier available at that time is selected and used to estimate a possible cost savings (if any). This is a theoretical bound, as it assumes that there is always enough capacity available on the cheapest carrier and that the transit-delay on the cheapest carrier is acceptable to the customer. In one or more embodiments, if the transit-time requirements are strict, the analysis can only restrict to selection of the cheapest carrier that also satisfies the transit-time and quantify any possible cost savings. The insights from this analysis can be helpful during capacity procurement on different carriers and when negotiating price with carriers.

Referring to the delay-cost tradeoffs analysis, if the customers are tolerant of additional delay in transit-time, then freight forwarders can provide more value to customers by providing them cheaper carriers options. For each past transaction, the cheapest carrier is identified whose transit-time is within x days more than the one selected (i.e., based on cost) and thus can quantify the total savings possible by exploiting the tradeoff between transit-time and cost.

Referring to the hot-spot analysis, the historical analysis module 528 can provide distribution of the total trade-lane traffic volume among different O-D pairs constituting the trade lane and among different carriers operating on the trade lane based on historical data. This information can be used for hot spot analysis, which is aimed at identifying top O-D pairs or carriers for different route performance metrics, e.g., top O-D pairs by traffic volume, by cost contribution, by potential cost-savings, etc. Similarly, highly rated carriers can be identified by traffic volume and by their cost contribution. Hot spot knowledge can be useful during carrier capacity procurement when volume discounts can be negotiated with carriers over hot O-D pairs. Also this knowledge helps to speed turnover time of bids by filtering out insignificant O-D pairs and concentrating on optimized bids for hot spots.

Referring to the business rules management module 530, business transactions of freight forwarders are governed by business rules. These rules govern the selection of carriers and routes by the forwarders during booking and bidding. Business rules are typically set by trade-lane managers and/or product managers and are not changed for long periods.

In a business rules management module 530, for example, suppose a forwarder operates on two trade-lanes, T1 and T2. Carrier A offers local volume discounts on T1 while Carrier B offers global volume discounts. Let a volume discount structure be as follows:

Carrier A: 50% for any TEU beyond 100K TEUs on T1, and

Carrier B: 40% for any TEU beyond 100K TEU globally,

where TEU stands for Twenty-foot Equivalent Unit and is a standard unit of shipping capacity. 1 TEU is equivalent to storage capacity of a 20×8×8 foot container. Let CA, T1 and CA, T2 be the cost per TEU of carrier A on T1 and T2. Similarly define CB, T1 and CB, T2. Let the demand be 120K TEUs on T1 and 80K on T2 and there be two business rules. Rule-1 says always select Carrier A, while Rule-2 says select Carrier-B. A forwarder cost is determined under the available business rules, in this case:

(Rule-1) 100K*CA, T1+20K*CA, T1*0.5+80K*CA, T2=110K*CA, T1+80K*CA, T2.

(Rule-2) 100K*CB, T1+20K*CB, T1*0.6+80K*CB, T2*0.6 (assuming first 100K are for T1)=112K*CB, T1+48K*CB, T2.

Depending on the values of CA, T1, CA, T2, CB, T1, CB, T2 either Rule-1 or Rule-2 results in a lower cost. In a scenario where these costs change over time, determining a most cost-effective business rule can account for a large portion of the volatility in these costs.

The business rules management module 530 manages business rules governing booking choices by identifying business rules that guide operators to select costly/slower carriers, and quantifying possible cost-savings/time-savings by simulating the effects of changes in business rules on different selections.

In particular, the business rules management module 530 enables the identification of business rules that result in reduced cost/time-savings by analyzing the business rules governing selections in the past transactions. The business rules management module 530 includes a simulation engine to simulate potential cost/time-savings by changing those business rules both on past transactions and in hypothetical future business scenarios. The simulation engine can also be used for sensitivity analysis of revenue to business rules. The business rules management module 530 provides an interactive UI for dynamically changing the business rules and simulating their effect on the cost/time-savings. Once a candidate set of business rules have been identified, the user can trigger rule amendment in the decision support system 504.

Referring to FIG. 11, a user can select a business rule (e.g., minimum cost route, minimum transit time route, higher tier carrier, etc.) to evaluate at block 1102. Optionally, at block 1103, one or more constraints can be associated with the selection of a business rule (e.g., include carrier volume, exclude carrier, exclude port, etc.). At block 1104, a load mix is specified. The load mix specifies an aggregate load in terms of a number of booking requests over a time period (e.g., month), where a single booking request can have several TEUs, and also the distribution of booking requests across different POL-POD pairs for the time period. At block 1105, when a load mix is requested for the time period, information for the periods (e.g., months) to be simulated is shown and can include, for example, the number of transactions/booking requests and the size of each booking request. In another example at block 1105, the information can include the percentage of total monthly load carried by different POL-POD pairs. This can be used to distribute the total simulated load across different POL-POD pairs in the simulation. Having selected a business rule (block 1102), any constraint (block 1104), and specified the load mix to set up a scenario, the scenario is run at block 1106 and data is output at block 1107.

The amendments to business rules can be due to changes in parameters of individual rules and/or changes in priority among rules in scenarios with more than one rule. The business rules management module 530 interacts with a booking decision support tool 901 to generate feasible routes for a given booking request. From the feasible routes, a highly rated route can be selected under the given rule scenario. In case of multiple qualifying routes, one or more of the routes can be selected randomly, selected according to a predetermined preference among multiple qualifying routes, etc. Average cost and transit-time under different rule scenarios can then be compared.

The inputs to an analytics view can include the set of trade lanes, the customer type and the set of carriers. By specifying an appropriate set of inputs, TLMs can restrict an analytics domain. Once the analysis type (e.g., historical analysis or business rules analysis) is specified, the analytics are executed over the input data and results are displayed (e.g., at 1107). The decision support system 504 includes one or more filters in the analysis view including filtering by Port of Lading (POL), Port of Departure (POD), container type, time window, etc. This can be used to drill down into the analytics results and identify performance bottlenecks.

A historical analysis module 528 provides different views, including an aggregate statistics view, and potential missed opportunity view. The aggregate statistics view reveals the distribution of aggregate traffic volume over the O-D pairs in the selected trade lane, which can be used for hot-spot analysis.

Exemplary output can include aggregate statistics view showing a distribution of total traffic volume on a trade lane along its constituent O-D port pairs, for example, showing that out of some 20 O-D pairs, 15 carry less than 5% of the total traffic, with 80% of the traffic accounted by top 5 O-D pairs.

Another exemplary output can show a potential missed opportunity view, in the context of a cost-savings analysis and a tradeoff analysis. For example, the view can show a distribution of total cost savings on the trade lane over different O-D pairs when a cheapest carrier is selected for each booking, assuming carriers have unlimited capacity. The output can show a possible savings (e.g., in percentage) if the cheapest carrier operating on one particular O-D pair has enough capacity. The output can show circumstances in which an O-D pair accounting for a majority of the savings is not the O-D pair carrying the majority of the traffic.

In another view, a possible cost savings can be shown in a case where the customer is tolerant of an additional delay of x days compared to the transit time of the fastest carrier on different O-D pairs. In such an example, an output can show cost savings (e.g., on a percentage basis) possible on a trade lane for x=2, 4, 6, 8, 10 and >10.

In yet another example, a business rules view provides an interface to make changes in current business rules, specify load mix for hypothetical business scenarios and simulate the effect of changes in business rules on the performance. A business scenario is specified by a booking request load mix and the set of business rules governing the booking choices. Exemplary business rules and their possible combinations for route selection include, for example, minimum cost route, minimum transit-time route, route with higher tier carriers, include volume discounts offered by carriers when calculating route cost, exclude specific carriers, and exclude specific ports. From the UI, the TLM can view the data associated with different rules. For example, current state tables corresponding to carrier tiers, volume discount parameters, available carrier capacity can be viewed and amended to simulate their effects.

The load mix for simulation can be created by specifying the aggregate load for each month and the percentage of total load carried by different POL-POD pairs. The simulation engine can be triggered once the load mix is defined and the business rules are selected. Once the simulation completes the view gets populated with different charts showing the total and average shipment cost per TEU and average transit time under the simulated business scenario. Multiple business scenarios with different business rules can be simulated interactively and their results can be visually compared. An exemplary business rules view chart for a hypothetical scenario can show a simulated load mix given by the pie chart and the metrics under three different business rules, higher tier carrier, minimum cost route, and minimum transit time route. This functionality can be used to identify a candidate set of rules to accomplish business goals in future.

By way of recapitulation, according to an exemplary embodiment of the present invention, simulation based analytics can be used to manage business rules in multimodal freight transportation industry. In one or more embodiments, a method includes obtaining a demand specification specifying a plurality of multi-modal freight shipment scenarios, each of the multi-modal freight shipment scenarios including at least a destination and an origin (see 903, FIG. 9); generating, using a booking tool, a plurality of feasible multi-modal routes for each of the multi-modal freight shipment scenarios using route information from a carrier database (see 906, FIG. 9), determining a plurality of business compliant routes among the plurality of feasible multi-modal routes for each of the multi-modal freight shipment scenarios using a rules specification specifying different business rules for each of the multi-modal freight shipment scenarios (see 907, FIGS. 9 and 1106, FIG. 11), comparing the multi-modal freight shipment scenarios by the business compliant routes determined for each respective one of the multi-modal freight shipment scenarios (see 912, FIG. 9), and identifying at least one business rule, among the different business rules, affecting an aggregate cost-savings using the comparison of the multi-modal freight shipment scenarios (see 912, FIG. 9). Reusability of feasible routes can be used for comparing different business scenarios and improving (e.g., speeding) the comparison of business scenarios. Candidate business rules for amendments can be identified by sensitivity of cost. Cost-benefit analysis of changes in business rules can be used to identify changes with substantial return on investment.

One or more embodiments of the invention, or elements thereof, can be implemented in the form of an apparatus including a memory and at least one processor that is coupled to the memory and operative to perform exemplary method steps.

One or more embodiments can make use of software running on a general purpose computer or workstation. With reference to FIG. 12, such an implementation might employ, for example, a processor 1201, a memory 1202, and an input/output interface formed, for example, by a display 1203 and an input device 1204. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 1201, memory 1202 and input/output interface such as display 1203 and keyboard can be interconnected, for example, via bus 1208 as part of a data processing unit 1200. Suitable interconnections, for example via bus 1208, can also be provided to a network interface 1205, such as a network card, which can be provided to interface with a computer network, and to a media interface 1206, such as a diskette or CD-ROM drive, which can be provided to interface with media 1207.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 1201 coupled directly or indirectly to memory elements 1202 through a system bus. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards, displays 1203, pointing devices, and the like) can be coupled to the system either directly (such as via bus 1208) or through intervening I/O controllers (omitted for clarity).

Network adapters such as network interface 1205 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 1200 as shown in FIG. 12) running a server program. It will be understood that such a physical server may or may not include a display and keyboard.

It should be noted that any of the methods described herein can include an additional step of providing a system comprising distinct software modules embodied on a computer readable storage medium; the modules can include, for example, any or all of the elements depicted in the block diagrams or other figures and/or described herein (e.g., modules and sub-modules shown in FIGS. 2-4 and 6-8). The method steps can then be carried out using the distinct software modules and/or sub-modules of the system, as described above, executing on one or more hardware processors 1201. Further, a computer program product can include a computer-readable storage medium with code adapted to be implemented to carry out one or more method steps described herein, including the provision of the system with the distinct software modules. In addition, databases 520, 522, 524 typically include records in persistent storage accessed by database management system software. The portal provided by element 504 may include hypertext markup language served out by a server to one or more client computers which, when executed on a browser of the client computer, creates a graphical user interface (GUI).

Exemplary System and Article of Manufacture Details:

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the terms “optimize,” “optimization,” and the like, when used in this specification, indicate an improvement in a condition, process or article of manufacture, and not necessarily a best or most effective use thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1-14. (canceled)

15. A computer program product for optimizing network yield during freight booking, the computer program product comprising a computer readable storage medium having program instructions embodied therewith, the program instructions executable by a processor to cause the processor to perform a method comprising:
obtaining a demand specification specifying a plurality of multi-modal freight shipment scenarios, each of the multi-modal freight shipment scenarios including at least a destination and an origin;
generating, using a booking tool, a plurality of feasible multi-modal routes for each of the multi-modal freight shipment scenarios using route information from a carrier database;
determining a plurality of business compliant routes among the plurality of feasible multi-modal routes for each of the multi-modal freight shipment scenarios using a rules specification specifying different business rules for each of the multi-modal freight shipment scenarios;
comparing the multi-modal freight shipment scenarios by the business compliant routes determined for each respective one of the multi-modal freight shipment scenarios; and
identifying at least one business rule, among the different business rules, affecting an aggregate cost-savings using the comparison of the multi-modal freight shipment scenarios.

16. The computer program product of claim 15, wherein generating the plurality of feasible multi-modal routes for each of the multi-modal freight shipment scenarios using the route information further comprises receiving a cost metrics specification, wherein the plurality of feasible multi-modal routes are generated using the cost metrics specification.

17. The computer program product of claim 15, wherein determining the plurality of business compliant routes further comprises receiving one or more constraints associated with at least one of the different business rules.

18. The computer program product of claim 15, further comprising receiving a load mix for each of the multi-modal freight shipment scenarios, the load mix specifying an aggregate load in terms of a number of booking requests over a time period, wherein the plurality of feasible multi-modal routes are generated using the load mix.

19. The computer program product of claim 15, further comprising outputting a report including a visualization of the comparison of the multi-modal freight shipment scenarios by the business compliant routes.
